(19) United States
(12) Patent Application Publication
(10) Pub. No.: US 2013/0169002 A1
(43) Pub. Date: Jul. 4, 2013

(54) VEHICLE DOOR HAVING MULTIFUNCTION CARRIER

(71) Applicants: Michael Möbius, Seelitz (DE); Frank Wagner, Nuernberg (DE); Ralph Hebe, Horb (DE)

(72) Inventors: Michael Möbius, Seelitz (DE); Frank Wagner, Nuernberg (DE); Ralph Hebe, Horb (DE)

(21) Appl. No.: 13/701,006

(22) PCT Filed: May 17, 2011
(86) PCT No.: PCT/EP2011/057974

§ 371 Date: Mar. 18, 2013

(30) Foreign Application Priority Data
May 31, 2010 (DE) 20 2010 007 547.3

(51) Int. Cl. B60J 5/04

(52) U.S. Cl. CPC B60J 5/0468
USPC 296/187.03

(57) ABSTRACT

A vehicle door is provided. The vehicle door comprising a door body, an assembly carrier connected with the door body for accommodating functional components of the vehicle door, and a multifunction carrier attached to the assembly carrier via a holding portion for connecting a door lock to the assembly carrier. A force absorption element arranged on the multifunction carrier is provided for supporting crash forces between portions of the door body.

### CROSS-REFERENCE TO A RELATED APPLICATION

This application is a National Phase Patent Application of International Patent Application Number PCT/EP2011/057974, filed on May 17, 2011, which claims priority of German Utility Model Application Number 20 2010 007 547.5, filed on May 31, 2010.

### BACKGROUND

This invention relates to a vehicle door.

Such vehicle door includes a door body, an assembly carrier connected with the door body for accommodating functional components of the vehicle door, and a multifunction carrier attached to the assembly carrier via a holding portion for connecting a door lock to the assembly carrier.

The door body for example can be formed in a manner known per se by a door inner panel and a door outer panel of a vehicle door and represents the supporting structure of the vehicle door.

The assembly carrier as part of a door module can be formed by a carrier plate and serve for accommodating different functional components, e.g. a window regulator, a loudspeaker, an airbag or the like, but can also be formed for example by the door inner panel or another portion of the supporting structure of the vehicle door.

Multifunction carrier is understood to be a separate carrier element which is connected with the assembly carrier via a holding portion and for example serves as lock carrier for connecting a door lock to the assembly carrier. The multifunction carrier also can accommodate further functional components, such as a door handle holder, and connect the same with the assembly carrier.

Conventionally, the multifunction carrier substantially serves as mounting aid. For example, a door lock arranged on the multifunction carrier is attached to the door body after insertion into the door body and hence is retained at the door, so that after the assembly the multifunction carrier as such no longer has any supporting function for the door lock.

A multifunction carrier of this type is known for example from EP 1 636 058 B1.

When a door lock is connected with the multifunction carrier, force transmission means—for example in the form of linkages or Bowden cables—, via which the door lock can be actuated, extend to the door lock in the condition mounted on the vehicle door. In particular in the case of a crash it must be prevented that forces act on these transmission means, in order to avoid an actuation of the door lock and an (inadvertent) opening of the vehicle door as a result of the acting crash forces.

In addition, it must be ensured that the components arranged on the multifunction carrier are protected against destruction in the case of a crash, in order to ensure their operational reliability also during a crash.

### SUMMARY

It is the object underlying the present invention to create a vehicle door as mentioned above, in which the functional components of the vehicle door—in particular safety-relevant functional components such as a door lock and a door handle mechanism—are protected in the case of a crash, so that the risk of a malfunction and/or of a loss of function is reduced in the case of a crash.

According to an exemplary embodiment of the invention a force absorption element arranged on the multifunction carrier is provided for supporting crash forces between portions of the door body.

The present invention proceeds from the idea to create a support in the case of a crash via a force absorption element for the protection of functional components of the vehicle door arranged in the region of the multifunction carrier. For this purpose, a force absorption element—also referred to as “crash pad”—is provided, which in the case of a crash creates a selective support of parts of the door body, so as to absorb forces occurring in the case of a crash—in particular during a side crash—and introduce the same into the door body. In the case of a crash, a protection of components arranged in the region of the multifunction carrier, for example a door lock, a door handle mechanism or the like, is provided via the force absorption element, so that the action of force onto the components arranged in the region of the multifunction carrier and also onto a force transmission means for actuating a door lock can at least be reduced.

The force absorption element is designed such that in normal operation the components are not impaired in their function, but are protected in the case of a crash.

The force absorption element in principle not only protects those functional components which are arranged directly on the multifunction carrier, but also other components which are located in the region of the multifunction carrier, but themselves are not connected with the multifunction carrier. Due to the fact that the force absorption element supports crash forces between a door outer panel and a door inner panel or the assembly carrier attached to the door inner panel (or a side impact carrier or a waist rail) in the case of a crash, the force absorption element attenuates the crash forces acting on the functional components, so that a malfunction (for example an undesired opening of a door lock in the case of a crash) or a loss of function (for example a non-actuatability of the door lock as a result of a crash) of functional components are avoided as far as possible. The force absorption element for example supports portions of the door body relative to each other such that a protected space is created for the functional components, into which parts of the door body or other parts cannot penetrate or only do so with difficulty.

In a preferred aspect, the force absorption element for example can be formed in one piece (i.e. integrally) with the holding portion for connecting the multifunction carrier with the assembly carrier. In this case, the force absorption element arranged on the multifunction carrier gets in contact with a portion of the door body, for example a door outer panel and/or a door inner panel of the vehicle door, in the case of a crash, in order to support crash forces.

It is, however, also conceivable to provide an (additional) force absorption element on the door body or the assembly carrier and form the same such that via the force absorption element a further support selectively is effected in the case of a crash.

The force absorption element arranged on the multifunction carrier can at least partly be formed deformable, and in the case of a crash come to rest against an associated portion of the door body under deformation. In the case of a crash, the force absorption element hence gets in contact with the associated portion of the door body, for example a door outer panel, is deformed and thereby establishes a non-positive connection with the door body.

To improve the support properties, the force absorption element also can be formed to positively support on an associated portion of the door body in the case of a crash. On the door body, for example the door outer panel or the door inner panel, suitable form-fit elements in the form of cutouts, protrusions, trunnions or the like can be mounted, which realize a form-fit geometry and in the case of a crash positively get in engagement with the force absorption element.

In an advantageous aspect, the force absorption element is cylindrically extended in a longitudinal direction and has a rib structure with ribs directed parallel to the longitudinal direction. The longitudinal direction of the cylindrical force absorption element substantially can correspond to the transverse vehicle direction, in order to absorb forces acting during a side impact. The term “cylindrical” here is to be understood in the general sense, i.e. describes a geometrical element which is described by two parallel, planar surfaces (bottom and top surfaces) and one shell surface, wherein the bottom and top surfaces can have an arbitrary contour (also referred to as “general cylinder”). The force absorption element in particular is not limited in its shape to a circular cylinder with a circular bottom surface.

The force absorption element is stiffened by the rib structure, wherein the rib structure can be formed for the selective direction-dependent stiffening. For example, via the ribs directed in longitudinal direction a stiffening preferably is achieved in longitudinal direction, whereas the force absorption element has a lower rigidity when a force acts transverse to the longitudinal direction.

On the multifunction carrier a positioning element can be provided in addition, which is connected with the holding portion and includes a guide portion for positioning a force transmission means connected with the door lock. The positioning means for example can be formed integrally with the force absorption element or be realized by the force absorption element itself, but can also be connected with the holding portion as a separate element, e.g. via an arm.

With its guide portion, the positioning element serves for guiding the force transmission means, for example a Bowden cable, and determines the path of extension of the force transmission means. The force transmission means for example can slidingly be guided on the guide portion of the positioning element. It is, however, also conceivable to firmly connect the force transmission means with the guide portion, for example latchingly attach the Bowden tube of a Bowden cable (by using a clip connection) to the guide portion.

By the positioning element it can be achieved on the one hand that the force transmission means is sufficiently protected in the case of a crash, for example in that it is guided in a region which is not impaired in the case of a crash with great probability.

On the other hand, the path of extension of the force transmission means can be determined by the positioning element such that it is ensured that movable components of the vehicle door, for example a window pane, cannot collide with the force transmission means, so that an application of force or even a tearing off of the force transmission means by movable parts of the vehicle door is safely excluded in normal operation.

The guide portion of the positioning element for example can be arranged at an end of the arm of the positioning element facing away from the holding portion and, by correspondingly shaping the arm, be guided on the multifunction carrier in the desired way.

The force transmission means advantageously is designed as Bowden cable, but in principle can also be realized by a linkage or the like.

As mentioned already, the force absorption element can be formed integrally with the positioning element or realize the positioning element. In the latter case, the force absorption element on the one hand serves for supporting crash forces in the case of a crash and on the other hand, in a synergetic dual use, for guiding the force transmission means for the door lock, wherein the guide portion for guiding the force transmission means is arranged on the force absorption element in a suitable way.

The force absorption element and the positioning element can of course also be formed separate from each other, wherein both for example are connected with the holding portion of the multifunction carrier, for example are made in one piece with the holding portion or formed as separate components and are connected with the holding portion by clipping, gluing, welding, screwing or riveting.

The multifunction carrier serves as mounting aid for connecting the door lock to the assembly carrier, but at the same time can also include further functional components, such as for example a door handle holder for an outside door handle and/or a guide rail for a window pane, so as to serve as an integral carrier module for various functional components, which can be mounted on the assembly carrier in modular fashion.

### BRIEF DESCRIPTION OF THE DRAWINGS

The idea underlying the invention will be explained in detail below with reference to the exemplary embodiments illustrated in the Figures:

FIG. 1 shows a side view of a vehicle door with a door body, on which an assembly carrier with a multifunction carrier for connection of a door lock is arranged.

FIG. 2 shows an enlarged detail view of the multifunction carrier of FIG. 1.

FIG. 3 shows a view of a multifunction carrier with a positioning element and force absorption element arranged thereon.

FIG. 4 shows a further view of the multifunction carrier of FIG. 3.

FIG. 5 shows a view of a further embodiment of a multifunction carrier with force absorption element arranged thereon.

FIG. 6 shows a view of again another embodiment of a multifunction carrier with force absorption element arranged thereon.

FIG. 7 shows a view of a further embodiment of a multifunction carrier with force absorption element arranged thereon.

FIG. 8 shows a view of an embodiment of a multifunction carrier without force absorption element.

FIG. 9 shows a view of again another embodiment of a multifunction carrier with force absorption element arranged thereon.

FIG. 10 shows a view of another embodiment of a multifunction carrier without force absorption element.

FIG. 11 shows a schematic view representing form-fit elements on the door body for positively supporting a force absorption element of the multifunction carrier.

### DETAILED DESCRIPTION

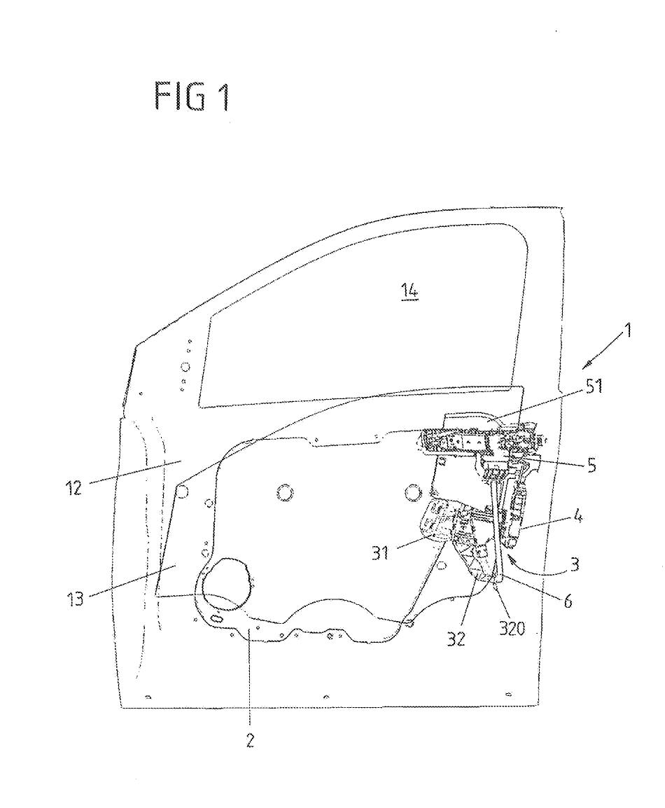

In a side view, seen from outside, FIG. 1 shows a vehicle door with a door body 1, which is formed by a door inner panel 12 and a door outer panel to be attached thereto (not shown in FIG. 1). On the door body 1, an assembly carrier 2 is arranged for accommodating functional components of the vehicle door, which in a manner known per se closes an opening in the door inner panel 12 and can include a window regulator (not shown for better clarity) for adjusting a window pane 13 closing a window opening 14.

On the assembly carrier 2, a multifunction carrier 3 furthermore is arranged, which serves as mounting aid and carries a door lock 4 and a door handle holder 5 and connects the same with the assembly carrier 2.

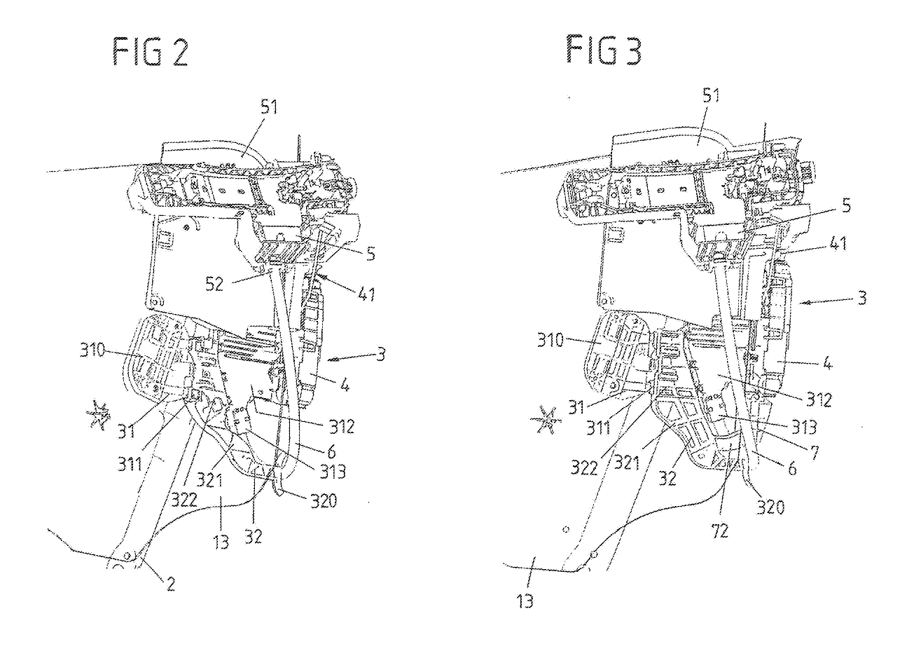

An enlarged view of the multifunction carrier 3 on the assembly carrier 2 is shown in FIG. 2. The multifunction carrier 3 is connected with the assembly carrier 2 via a holding portion 31, wherein the holding portion 31 is formed in two parts with a fastening portion 310 for attachment to the assembly carrier 2 and a connecting portion 312 for connection with the door lock 4. The fastening portion 310 and the connecting portion 312 are positively connected with each other via a clip or slide connection 311.

The door handle holder 5 is connected with the housing of the door lock 4 via a plug connection 41 (see for example FIG. 5). On the door handle holder 5 a protective shield 51, for example made of plastics (in particular a composite plastic material) or metal, furthermore is arranged, which realizes a theft protection and is meant to prevent an access to the door lock 4 from outside.

As can be taken from the synopsis of FIG. 1 and FIG. 2, the window pane 13 extends through between the holding portion 31 and the door handle holder 5 with the protective shield 51 arranged thereon. Seen from outside, the door handle holder 5 thus is arranged before the window pane 13 and thus accessible from outside, while the holding portion 31 as seen from outside is arranged behind the window pane 13 and establishes the connection with the assembly carrier 2 attached to the door inner panel 12.

To transmit an actuating force from an outside door handle connected with the door handle holder 5 to the door lock 4, a force transmission means in the form of a Bowden cable 6 is provided, which extends between the door handle holder 5 and the holding portion 31 and via connectors 52 (on the door handle holder 5) and 313 (on the holding portion 31) is connected with the door handle holder 5 on the one hand and with the holding portion 31 on the other hand.

To ensure that the Bowden cable 6 cannot collide with the window pane 13, to prevent an action of force or even a tearing off of the Bowden cable 6 during an adjustment of the window pane 13, a positioning element 32 is provided, which includes an arm 321 connected with the holding portion 31 via a clip or slide connection 322 and a guide portion 320 arranged on the arm 321 for slidingly guiding the Bowden cable 6.

Due to the sliding guidance of the Bowden cable 6 on the guide portion 320, the path of extension of the Bowden cable 6 is defined such that it prevents a collision of the Bowden cable with the window pane 13. The Bowden cable 6 hence extends around the outer boundary of the window pane 13 from the door handle holder 5 towards the holding portion 31 of the multifunction carrier 3.

It is also conceivable to fix the Bowden cable 6 on the guide portion 320 for example via a clip connection.

If no firm connection is provided, as in the embodiment of FIG. 2, the guide portion 320 should provide a comparatively broad guide surface, in order to prevent that the Bowden cable 6 can slip from the guide portion 320.

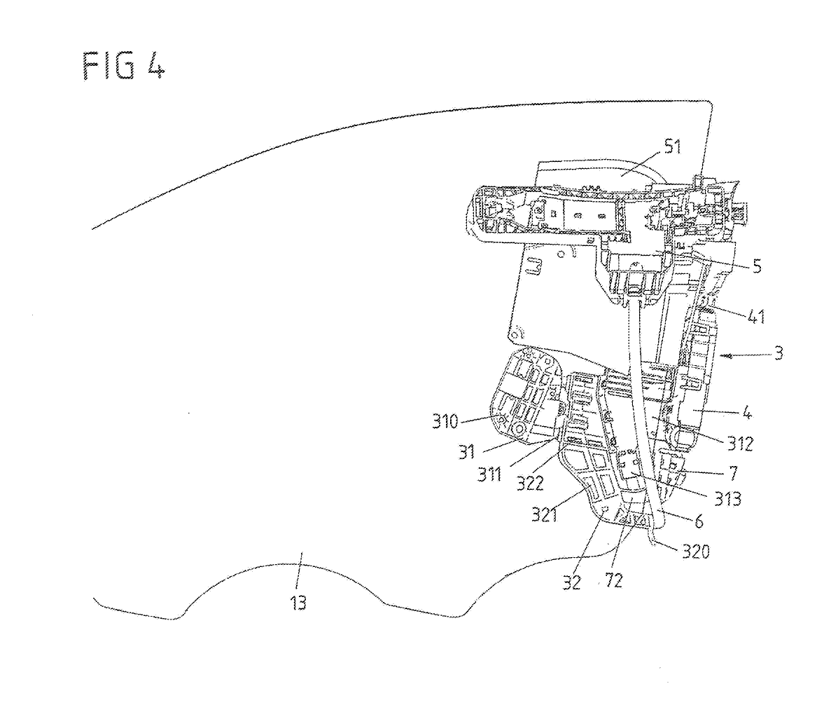

In FIGS. 3 and 4 an embodiment of a multifunction carrier 3 is shown, which in addition to the embodiment of FIGS. 1 and 2 includes a force absorption element 7 integrally connected with the positioning element 32 via an arm 72. The force absorption element 7 serves the selective support of crash forces in the case of a crash, in that the force absorption element 7 is formed and provided to get in contact with the door outer panel located on the outside of the force absorption element 7 and/or with the door inner panel 12 located on the inside of the force absorption element 7 (see FIG. 1) or with the assembly carrier 2 (or also a side impact carrier or a door sill) in the case of a crash, so as to establish a flux of force between parts of the door body 1 and create a support in the case of a crash.

The force absorption element 7 can be formed such that components arranged in the region of the multifunction carrier 3, for example the door lock 4 and the Bowden cable 6, are protected during a side impact, in that the acting crash forces are dissipated via the force absorption element 7 and crash forces are not, or at least only to a reduced extent, applied to the Bowden cable 6 and the door lock 4.

In the embodiment of FIGS. 3 and 4, the force absorption element 7 below the door lock 4 and above the positioning element 32 is formed as component integrally connected with the positioning element 32. The positioning element 32 here extends downwards from the holding portion 31 and guides the Bowden cable 6 around the window pane 13 on the outside.

FIGS. 5 to 8 show embodiments of multifunction carriers 3, in which the positioning element 32 each extends upwards from the holding portion 31 and correspondingly guides the Bowden cable 6, wherein the Bowden cable 6 in turn is suitably guided past a window pane 13, in order to avoid a collision with the window pane 13 during an adjustment operation.

In the embodiment of FIG. 5, a force absorption element 7 is arranged below the holding portion 31 in the region of the connector 313.

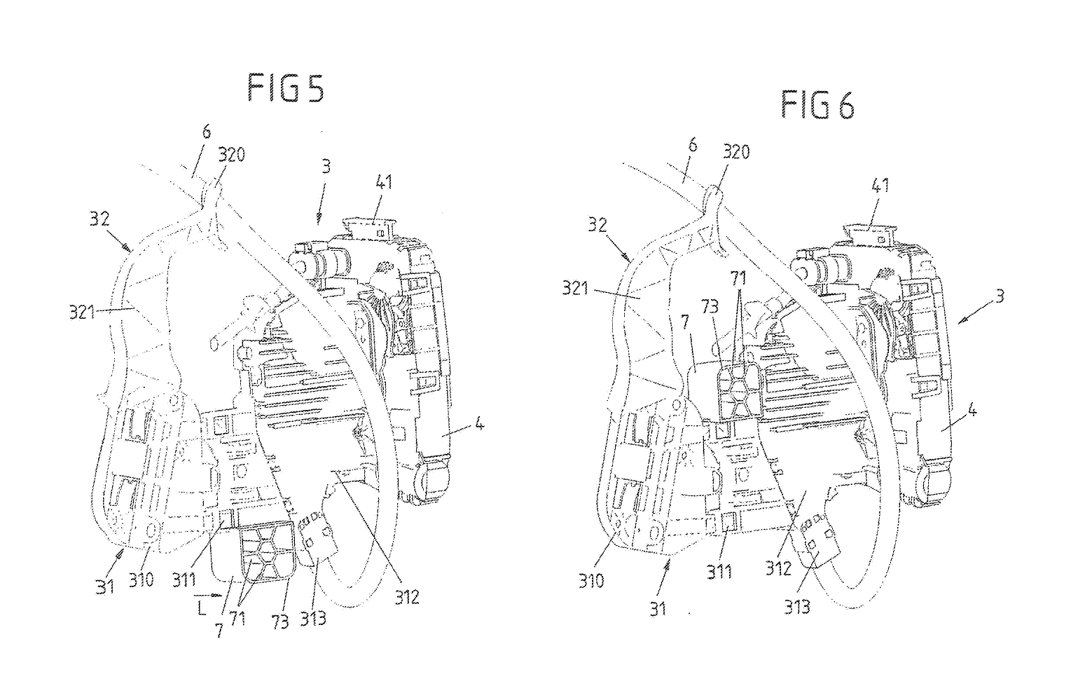

In the embodiment of FIG. 6, the force absorption element 7 is arranged above the holding portion 31.

In the embodiment of FIG. 7, the force absorption element 7 in turn is arranged below the holding portion 31, but not (as in the embodiments of FIGS. 5 and 6) integrally connected with the connecting portion 311 of the holding portion 31, but connected to the connecting portion 311 via an arm 72.

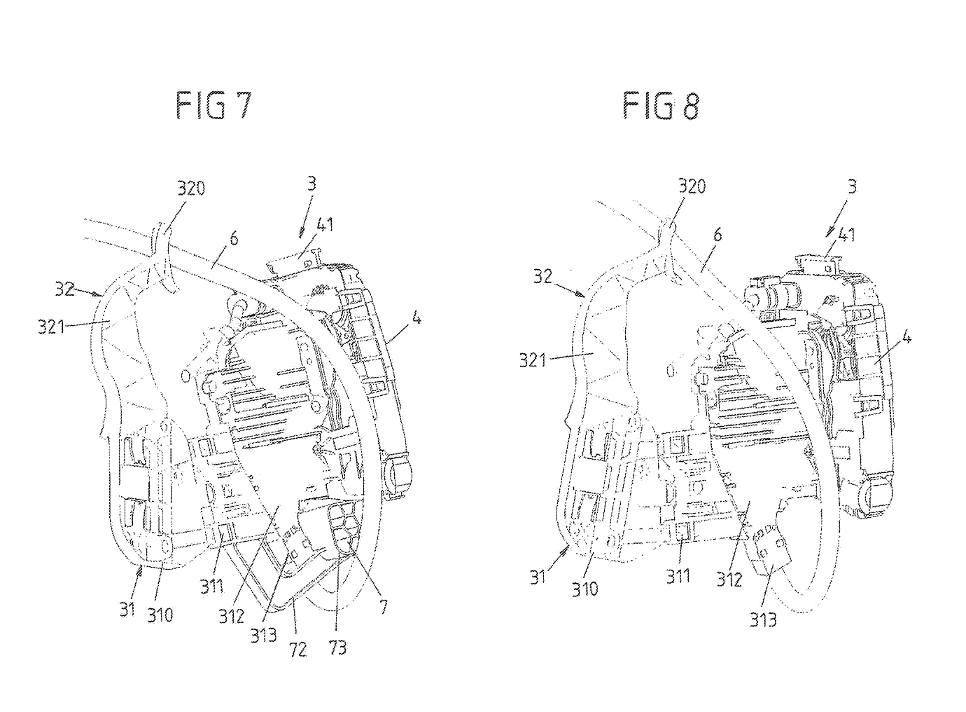

FIG. 8 shows an embodiment of a multifunction carrier without force absorption element.

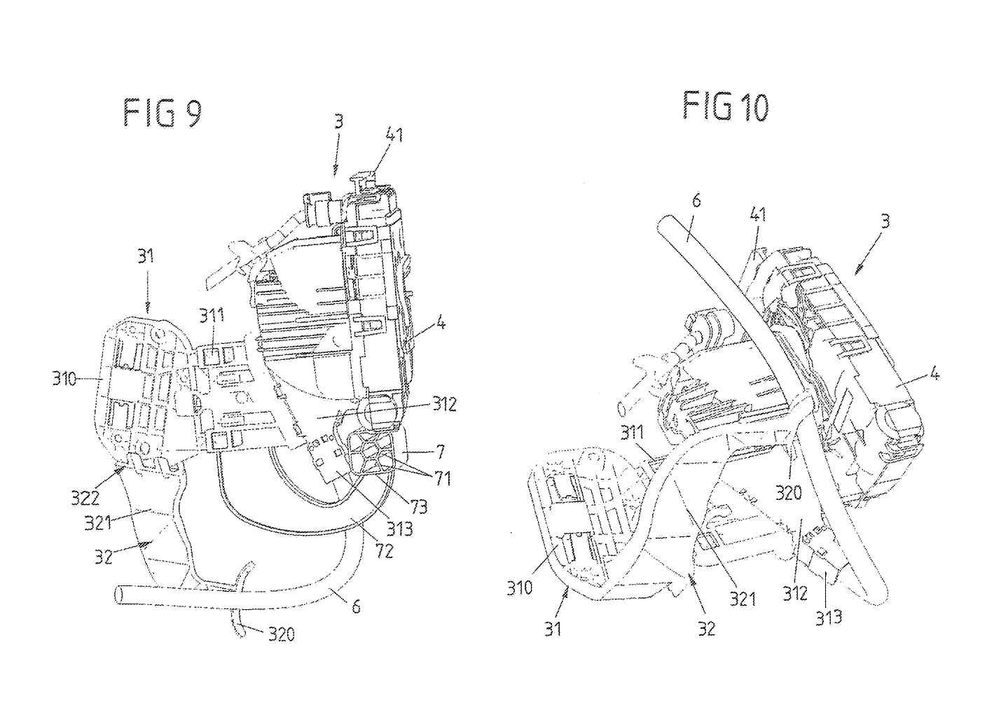

FIG. 9 shows a multifunction carrier 3 with a positioning element 32 extending downwards and a force absorption element 7 arranged below the door lock 4, which is connected to the holding portion 31 via an arm 72.

FIG. 10 finally shows an embodiment of a multifunction carrier 3 without force absorption element, in which the positioning element 32 is directed out of the plane of the holding portion 31 and correspondingly guides the Bowden cable 6. Via its arm 321, the positioning element 32 is connected with the fastening portion 310 of the holding portion 31 in a vertical or almost vertical fashion.

In the embodiments of a multifunction carrier 3 with force absorption element 7 arranged thereon, which are shown in the Figures, this preferably, as shown in FIGS. 5, 6, 7 and 9, is formed as longitudinally extended component with an inner rib structure with ribs 71. The ribs 71 extend in a longitudinal direction L (see FIG. 5) which substantially corresponds to the transverse direction of the vehicle with properly arranged multifunction carrier 3 and closed vehicle door (the longitudinal direction L hence is substantially vertical to the plane of extension of the door outer panel and the door inner panel 12 (see FIG. 1)).

The ribs 71 serve for stiffening the force absorption element 7 in particular with an action of force along the longitudinal direction L and hence in a direction-dependent way. The force absorption element 7 has a high rigidity along the longitudinal direction L, but a reduced rigidity transverse to the longitudinal direction L. The force absorption element 7 hence preferably can support forces in the longitudinal direction L, i.e. in transverse vehicle direction, in order to support and absorb crash forces in particular during a side impact.

The force absorption element 7 is formed and provided to get in contact with the door body 1, in particular a door outer panel 11 and/or the door inner panel 12 in the case of a crash, in order to provide a supporting flux of force and a force dissipation in the case of a crash.

To provide a safe support of the force absorption element 7 on the door body 1, the force absorption element 7 can at least partly be formed deformable, in order to rest against an associated portion of the door body 1 under deformation in the case of a crash and thus create a safe support.

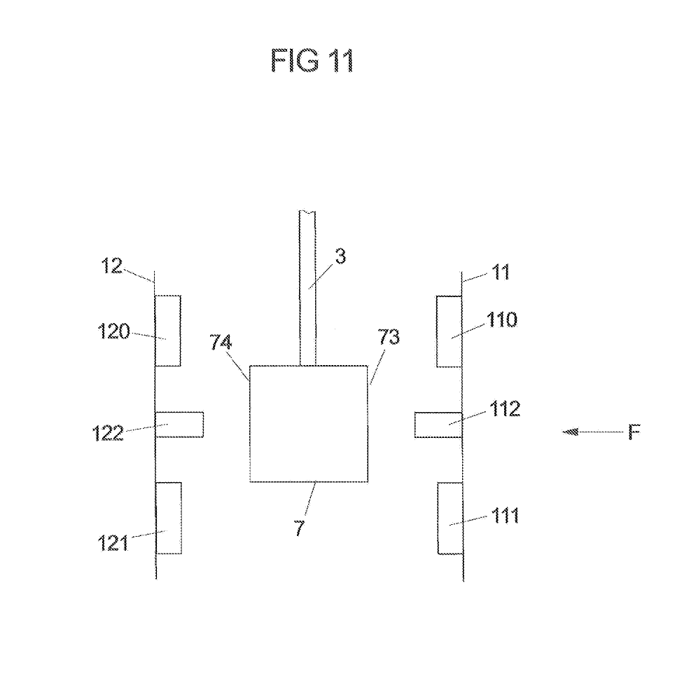

Alternatively or in addition it can also be provided that the support of the force absorption element 7 on the associated portion of the door body 1 is effected by establishing a form fit. This is schematically shown in FIG. 11.

FIG. 11 schematically shows a door outer panel 11 and a door inner panel 12, between which the multifunction carrier 3 with the force absorption element 7 arranged thereon is located. The force absorption element 7 is designed as cylindrical component as described above and with an outer surface 73 faces the door outer panel 11 and with an inner surface 74 faces the door inner panel 12.

On the door outer panel 11 and on the door inner panel 12 form-fit elements 110, 111, 112 and 120, 121, 122 each are arranged, which serve for establishing a form fit with the force absorption element 7 in the case of a crash.

If a force F acts on the door outer panel 11 during a side impact, the door outer panel 11 is urged towards the force absorption element 7, and the force absorption element 7 is brought in contact with the door inner panel 12 by partly upsetting or crumpling the vehicle door. As a result, the force absorption element 7 gets in contact with the door outer panel 11 and/or the door inner panel 12, so that the form-fit elements 112, 122 positively engage into the force absorption element 7 in cutouts formed between the ribs 71 (see e.g. FIG. 5) and in addition the force absorption element 7 comes to lie between the form-fit elements 110, 111 on the side of the door outer panel and between the form-fit elements 120, 121 on the side of the door inner panel. In this way, the force absorption element 7 is positively supported both on the door outer panel 11 and on the door inner panel 12 and thereby safely dissipates the acting crash forces by bypassing the components arranged in the region of the force absorption element 7.

The idea underlying the invention is not limited to the exemplary embodiments described above, but rather can also be employed in completely different embodiments. In particular, it is also possible to employ more than one force absorption element, for example two or more force absorption elements, which in a suitable way provide a support of parts of the door body at different points.

1-14. (canceled)

15. A vehicle door, comprising
a door body,
an assembly carrier connected with the door body for accommodating functional components of the vehicle door,
a multifunction carrier attached to the assembly carrier via a holding portion for connecting a door lock to the assembly carrier, and
a force absorption element arranged on the multifunction carrier for supporting crash forces between portions of the door body.

16. The vehicle door according to claim 15, wherein the force absorption element is formed to support crash forces between a door outer panel and a door inner panel or the assembly carrier attached to the door inner panel in the case of a crash.

17. The vehicle door according to claim 16, wherein the force absorption element is formed integrally with the multifunction carrier, preferably the holding portion.

18. The vehicle door according to claim 15, wherein the force absorption element is at least partly deformable and is formed to support on an associated portion of the door body under deformation in the case of a crash.

19. The vehicle door according to claim 15, wherein the force absorption element is formed to positively support on an associated portion of the door body in the case of a crash.

20. The vehicle door according to claim 15, wherein the force absorption element is extended in a longitudinal direction and has a rib structure with ribs directed parallel to the longitudinal direction.

21. The vehicle door according to claim 15, wherein the multifunction carrier
carries a door lock which is connected with a force transmission means for actuating the door lock, and
includes a positioning element which is connected with the holding portion and comprises a guide portion for positioning the force transmission means.

22. The vehicle door according to claim 21, wherein the positioning element is connected with the holding portion of the multifunction carrier via an arm.

23. The vehicle door according to claim 21, the force transmission means is slidingly guided on the guide portion.

24. The vehicle door according to claim 21, wherein the force transmission means is firmly connected with the guide portion.

25. The vehicle door according to claim 21, wherein the guide portion is arranged at an end of the positioning element facing away from the holding portion.

26. The vehicle door according to claim 21, wherein the force transmission means is formed as a Bowden cable.

27. The vehicle door according to claim 21, the force absorption element is formed integrally with the positioning element.

28. The vehicle door according to claim 15, wherein a door handle holder and/or a guide rail for a window pane additionally are arranged on the multifunction carrier.
